(19) United States
(12) Patent Application Publication
(10) Pub. No.: US 2010/0004573 A1
(43) Pub. Date: Jan. 7, 2010

(54) APPARATUS FOR PERFORMING A MASSAGE AT THE SPINE

(76) Inventor: Alain Mairet, Evian (FR)

Correspondence Address: MYERS WOLIN, LLC, 100 HEADQUARTERS PLAZA, North Tower, 6th Floor, MORRISTOWN, NJ, 07960-6834, US

(21) Appl. No.: 12/556,852

(22) Filed: Sep. 10, 2009

Related U.S. Application Data
(63) Continuation of application No. PCT/FR07/01994, filed on Dec. 5, 2007.

(30) Foreign Application Priority Data
Dec. 12, 2006 (FR) 06 10788

(51) Int. Cl. A61H 1/00

(52) U.S. Cl. 601/46; 601/136

(57) ABSTRACT

An apparatus comprises at least two massaging means arranged side by side, each including a vibration application area designed to be applied on the patient in order to transmit vibrations; the two massaging means are located at a distance from each other such that one of said massaging means can be applied essentially opposite the transverse apophysis of a vertebra while the other massaging means can simultaneously be applied essentially opposite the other transverse apophysis of the same vertebra; inclination detecting means arranged along a direction parallel to the direction from one massaging means to the other, this inclination detecting means being for detecting a level difference between the application areas of the two massaging means; and means for operating one or the other of said massaging means according to the level of difference detected between said application areas.

The present application is a continuation of PCT/FR2007/001994, filed Dec. 5, 2007, which claims priority to French Application No. 06 10788, filed Dec. 12, 2006, the contents of which are incorporated herein by reference.

The present invention concerns an apparatus for performing a massage at the spine.

A spine can comprise one or several vertebrae which are more or less displaced in relation to their normal position, in particular one of several vertebrae having suffered a pivoting along the longitudinal axis of the spine. These defective positions are at the origin of recurring pains which may be intense, the displaced vertebra(e) causing painful muscular imbalances and more or less compressing the roots of the spinal nerves.

In order to soothe these ailments, it is known to perform massages to try to progressively bring the vertebra(e) back to their normal positions. The areas to be massaged are, however, detected relatively imprecisely and these massages are not always completely effective.

In some cases, the vertebral pivoting can be small, in the vicinity of a few degrees, and can be nearly undetectable by the naked eye or by manual palpation, and vertebrae pivoted in different directions can follow one another on a same spine. It is then difficult to apply massages to the patient which are precisely adapted to the concerned spine and which are fully effective.

The present invention aims to resolve these drawbacks.

To this end, the apparatus which it concerns comprises:
at least two massaging means arranged side by side, each including a vibration application area designed to be applied on the patient in order to transmit vibrations; the two massaging means are located at a distance from each other such that one of said massaging means can be applied essentially opposite the transverse apophysis of a vertebra while the other massaging means can simultaneously be applied essentially opposite the other transverse apophysis of the same vertebra;
inclination detecting means arranged along a direction parallel to the direction from one massaging means to the other, this inclination detecting means being for detecting a level difference between the application areas of the two massaging means;
means for operating one or the other of said massaging means according to the level of difference detected between said application areas.

Thus, the apparatus according to the invention can be moved slowly along a spine with each of the application areas of the massaging means moving essentially above the transverse apophyses of the vertebrae; in case of a vertebra having suffered pivoting along the longitudinal axis of the spine, one of the application areas is brought into a raised position in relation to the other application area, and the resulting level of difference is detected by the inclination detecting means; the operating means are then activated in order to operate the higher massaging means and thus perform a massage of the tissue surrounding the vertebra, at a lateral area in relation to the spine, located essentially opposite the transverse apophysis of the pivoted vertebra.

The apparatus according to the invention thus not only makes it possible to precisely detect defective positions of vertebrae, but also to apply a massage at a precise location, of a nature to make it possible to progressively return the vertebra to a normal position. The return of this vertebra to this normal position can be detected immediately by the inclination detecting means, the massage being stopped immediately upon this detection.

Thus, the apparatus according to the invention makes it possible to fully treat a spine having one or several pivoted vertebrae, even when the pivot angle is small, to treat vertebrae pivoted in different directions which may follow one another on a spine, and to perform a suitable massage in order to return the vertebra(e) to a normal position. A pilot study has already shown an 84% decrease in the pain expressed after 30 days.

The operating means could be activated by the simple detection of the aforementioned inclination; preferably, however, these means comprise control means which must be activated by the user in order to operate the massaging means. This operating can thus be completely controlled.

The control means can in particular comprise a push button located at each vibrating head. The user thus presses the push button of the massaging means he wishes to activate.

The apparatus can advantageously comprise a support surface surrounding each push button, on which the user can push when the corresponding massaging means is activated.

The user thus presses the push button and keeps this push button pressed in while, in the same movement, pushing on the massaging means, this pushing promoting the transmission of vibrations.

Advantageously, the apparatus comprises at least two indicator means, one of which is located on the side of one of the massaging means and the other on the side of the other massaging means, one or the other of these indicator means being activated in case of detection by the inclination detecting means of a level difference between said application areas. In particular, the indicator means which is/are activated are those located on the massaging means having the higher application area.

These indicator means can in particular comprise pilot lamps located on the body of the apparatus.

These indicator means can also comprise lighting means for the aforementioned push buttons.

The apparatus according to the invention can also comprise a handgrip handle making it possible to maintain it and move it along a spine.

Said massaging means can be vibrating heads.

Said inclination detecting means can be a clinometers.

The invention will be well understood, and other characteristics and advantages thereof will appear, in reference to the appended diagrammatic drawing, illustrating, as non-limiting examples, two possible embodiments of the apparatus it concerns.

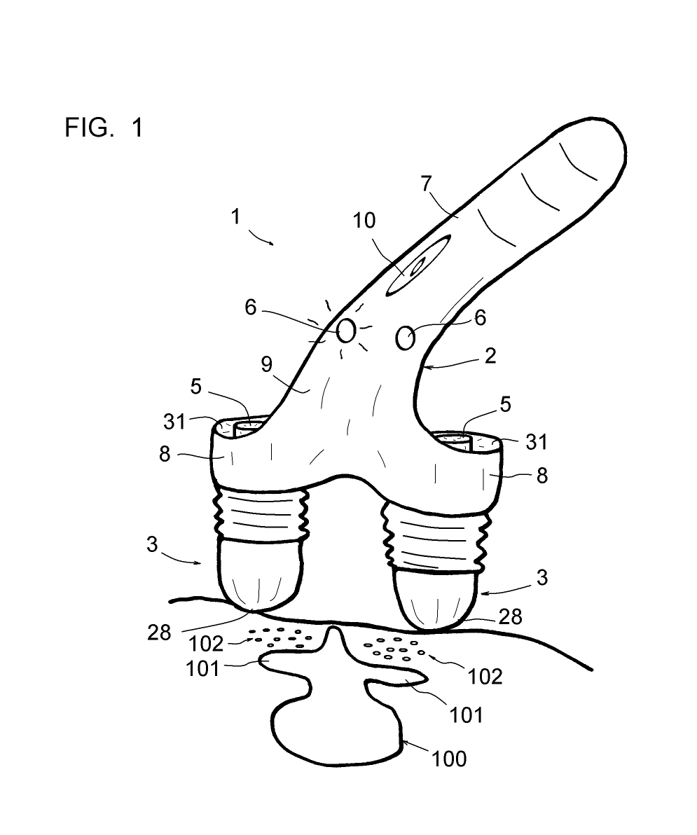

FIG. 1 is a perspective view according to a first embodiment, this figure also showing, very diagrammatically, the back of a patient and a vertebra in cross-section;

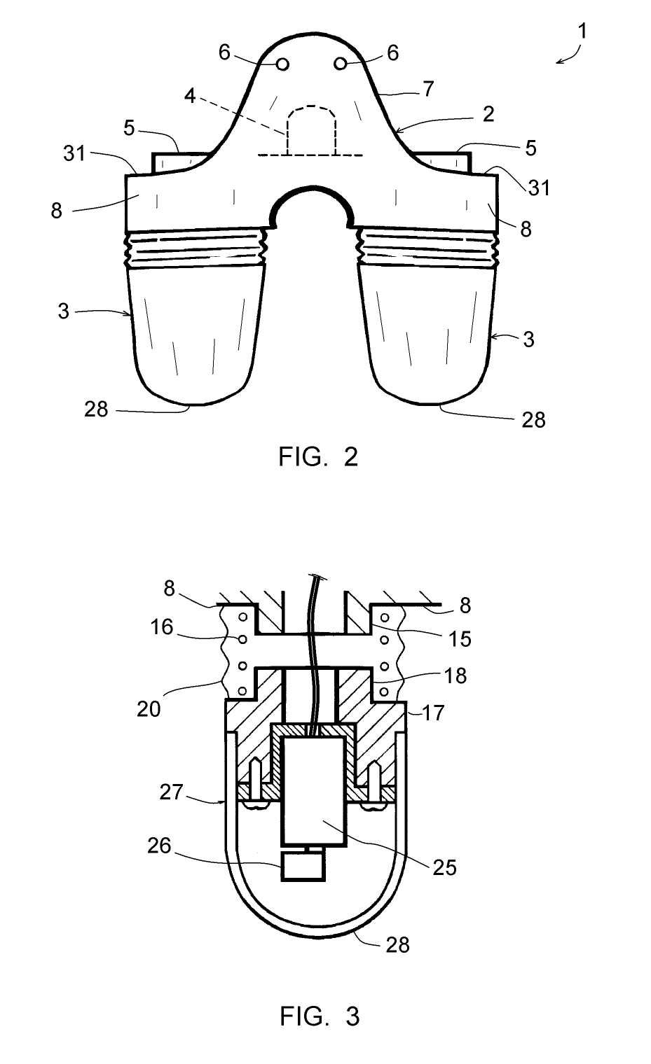

FIG. 2 is a front view of this apparatus;

FIG. 3 is a cross-section of one of the two vibrating heads comprised by the device;

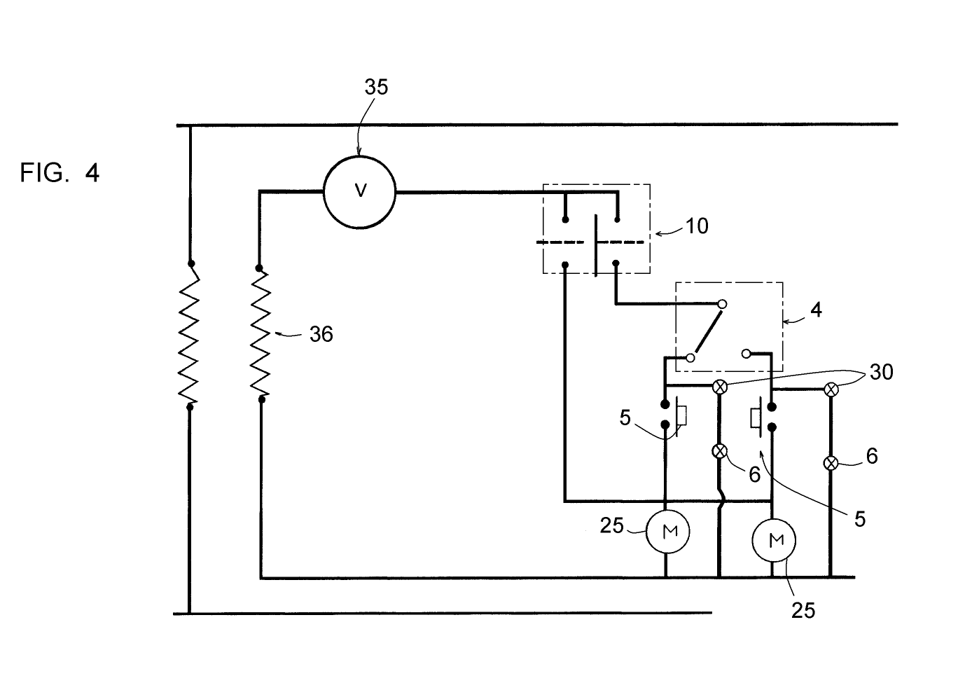

FIG. 4 is a view of the simplified electrical circuit of this apparatus, and

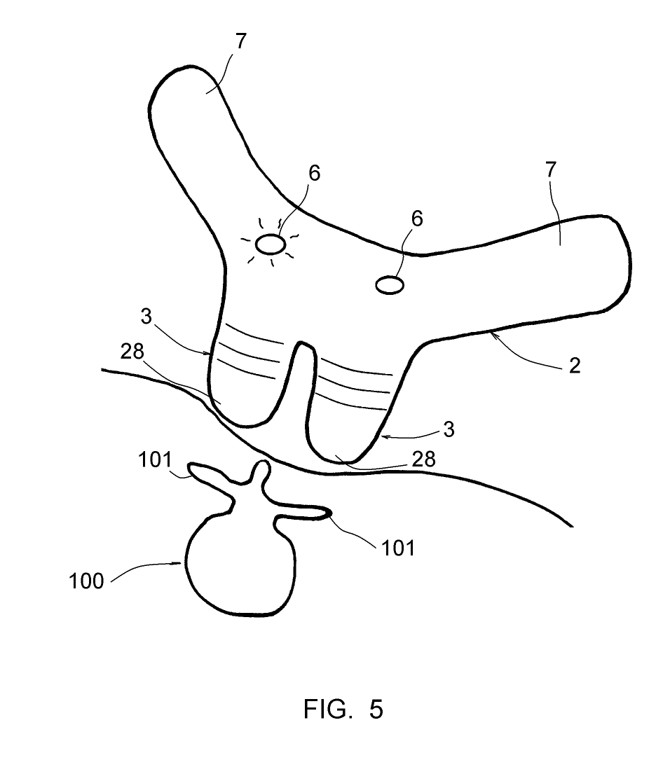

FIG. 5 is a perspective view of another possible embodiment of the apparatus.

FIGS. 1 and 2 illustrate an apparatus 1 for performing a massage at the spine, comprising a body 2, two vibrating heads 3, a clinometer 4, push buttons 5 and two pilot lamps 6.

The body 2 comprises a median elongated portion 7 and, at one end of this portion 7, two lateral extensions 8 extending in directions opposite each other, connected to the portion 7 by a rounded intermediate portion 9.

The portion 7 constitutes a handgrip handle of the apparatus 1 and can be used to store electrical power batteries for this apparatus. Its longitudinal axis may be more or less angulated in relation to the plane containing the extensions 8, i.e. either greatly angulated as illustrated in FIG. 1, or slightly angulated, or even parallel to this plane, as shown in FIG. 2.

The portion 7 comprises a switch 10 with three positions, i.e. a stopped position of the apparatus 1, a position for operating the two vibrating heads 3, and a position for activating a “detect” function, for operating only one of the two vibrating heads 3 depending on the detection by the clinometers 4 of a level of difference between these two vibrating heads 3, as will be explained later.

The portion 7 also comprises the two pilot lamps 6 arranged side by side essentially at the intermediate portion 9. One of the lamps 6 is thus located on the side of an extension 8 and the other lamp is located on the side of the other extension 8.

Each vibrating head 3 is mounted on the corresponding extension 8, on the side of the extension 8 opposite that on which the portion 7 is found, and each push button 5 is located on the side of the extension 8 on which the portion 7 is found.

It appears in FIG. 3 that each extension 8 comprises a stud 15 around which the end of a spring 16 is engaged, and held, and that each vibrating head 3 comprises a body 17 forming a corresponding stud 18, on which the other end of the spring 16 is engaged and held. The spring 16 is covered by a bellows 20.

The body 17 comprises a motor 25, on the shaft of which an eccentric counterweight 26 is mounted, and comprises a lower bell 27 forming a rounded end surface 28. As is understood, the driving in rotation of the counterweight 26 by the motor 25 generates vibrations of the entire vibrating head 3, made possible by the spring 16, and the surface 28 constitutes an application area on the patient for the vibrations generated by the vibrating head 3.

Each push button 5 controls, when it is pushed in, the operation of the corresponding vibrating head 3. This push button 5 is transparent and comprises a light 30, visible in FIG. 4.

It also appears in FIGS. 1 and 2 that each extension 8 forms a support surface 31 surrounding each push button 5, on which the user can press when the corresponding vibrating head 3 is activated.

As shown by FIG. 1, the two vibrating heads 3 are located at a distance from each other such that one of these vibrating heads 3 can be applied essentially opposite the transverse apophysis 101 of a vertebra 100 while the other vibrating head 3 can simultaneously be applied essentially opposite the other transverse apophysis 101 of this same vertebra 100.

The clinometer 4 is arranged along a direction parallel to the direction going from one vibrating head 3 to the other, and can detect a level of difference between the application areas 28 of the two vibrating heads 3. This can in particular be a clinometer referenced UV-2HF-SW2 by the company MEIRI in BONNEUIL (France, F-94864), having an inclination detection sensitivity of less than one degree.

FIG. 4 shows the electrical diagram of the apparatus 1. Other than the elements already described, this diagram shows a dimmer 35 and a transducer 36 for transforming 230 V current into 18 V current.

In practice, the apparatus 1 is moved slowly along a spine with each of the application areas 28 of the vibrating heads 3 moving substantially above the transverse apophyses 101 of the vertebrae 100; in case of a vertebra 100 having suffered a pivoting along the longitudinal axis of the spine, one of the application areas 28 is brought to a raised position in relation to the other application area 28, and the resulting level of difference is detected by the clinometer 4; the latter causes the push button 5 and the pilot light 6 located on the higher side to light up; the user can then push in the lit button 5 in order to operate the corresponding vibrating head 3, and can push on the surface 31 in order to favor the transmission of the vibrations generated by the vibrating head 3.

A massage of the tissues 102 surrounding the vertebra 100 is thus performed, at a lateral area in relation to the spine, located essentially opposite the transverse apophysis 101 of the pivoted vertebra.

The apparatus 1 thus not only makes it possible to precisely detect defective positions of vertebrae 100, but also to apply a massage to a precise location, of a nature to be able to progressively return the vertebra to a normal position. The return of this vertebra to this normal position can be detected immediately by the clinometer 4, which is the pilot light 6 lit until then, and the massage can then be immediately sopped upon this detection.

FIG. 5 shows an alternative embodiment of the invention. The same reference numbers as before are used to designate identical parts.

In this case, the body 2 comprises two portions 7 diverging in relation to each other like “handlebars”.

As appears from the preceding, the invention provides an apparatus making it possible to perform a massage at the spine, having the determining advantage of making it possible to fully treat a spine comprising one or several pivoted vertebrae, even when the pivot angle is small, to treat vertebrae pivoted in different directions which may follow one another on a spine, and perform a suitable massage to return the vertebra(e) to a normal position.

It goes without saying that the invention is not limited to the embodiment described above as an example, but that it extends to all embodiments covered by the appended claims.

1. Apparatus (1) for performing a massage at the spine, characterized in that it comprises:
at least two massaging means (3) arranged side by side, each including a vibration application area (28) designed to be applied on the patient in order to transmit vibrations; the two massaging means (3) are located at a distance from each other such that one of said massaging means (3) can be applied essentially opposite the transverse apophysis (101) of a vertebra (100) while the other massaging means (3) can simultaneously be applied essentially opposite the other transverse apophysis (101) of the same vertebra (100);
inclination detecting means (4) arranged along a direction parallel to the direction from one massaging means (3) to the other, this inclination detecting means (4) being for detecting a level difference between the application areas (28) of the two massaging means (3); and
means (5) for operating one or the other of said massaging means (3) according to the level of difference detected between said application areas (28).

2. Apparatus (1) according to claim 1, characterized in that the operating means comprise control means (5) which must be activated by the user in order to operate the massaging means (3).

3. Apparatus (1) according to claim 2, characterized in that the control means comprise a push button (5) located at each vibrating head (3).

4. Apparatus (1) according to claim 1, characterized in that it comprises a support surface (31) surrounding each push button (5), on which the user can push when the corresponding massaging means (3) is activated.

5. Apparatus (1) according to claim 1, characterized in that it comprises at least two indicator means (6), one of which is located on the side of one of the massaging means (3) and the other on the side of the other massaging means (3), one or the other of these indicator means (6) being activated in case of detection by the inclination detecting means (4) of a level difference between said application areas (28).

6. Apparatus (1) according to claim 5, characterized in that said indicator means can in particular comprise pilot lamps (6) located on the body (2) of the apparatus (1).

7. Apparatus (1) according to claim 5, characterized in that said indicator means comprise lighting means (30) for the push buttons (5).

8. Apparatus (1) according to claim 1, characterized in that it comprises a handgrip handle (7) making it possible to maintain it and move it along a spine.

9. Apparatus (1) according to claim 1, characterized in that said massaging means are vibrating heads.

10. Apparatus (1) according to claim 1, characterized in that said inclination detecting means is a clinometers.
